(19) United States
(12) Patent Application Publication
(10) Pub. No.: US 2002/0113138 A1
(43) Pub. Date: Aug. 22, 2002

(54) Water-ball structure

(76) Inventor: Barry Shih, Taipei (TW)

Correspondence Address: DOUGHERTY & TROXELL, SUITE 1404, 5205 LEESBURG PIKE, FALLS CHURCH, VA, 22041, US

(21) Appl. No.: 09/784,188

(22) Filed: Feb. 16, 2001

(51) Int. Cl. B05B 17/08

(52) U.S. Cl. 239/17

(57) ABSTRACT

The present invention relates to a Water-Ball structure, which is comprised of a base, a water pumping and draining device, a model, a waterproof separating plate, a motor, and a transparent upper lid. Wherein, an appropriate proportion of oil and water are poured into a closed space, which is formed by the waterproof separating plate and the transparent upper lid. By the characteristic that oil is lighter than water and by the motion of the water pumping and draining device, the water, sunk in lower layer, is injected into upper oil layer through the pipelines inside the interior of the model. The major characteristic is that each magnetic element is arranged respectively on the rotating blade of the water pumping and draining device and the axis center of the motor. When the motor, arranged under the waterproof separating plate, is rotating, it will directly active the rotating blade located above the waterproof separating plate to rotate by magnetic power. That is, without drilling hole in the waterproof separating plate, the motor can directly active the rotating blade to rotate and to reach the solid and better function of waterproof.

### FIELD OF THE INVENTION

The present invention relates to a Water-Ball structure, especially to a Water-Ball structure with an application of the principle of magnetic power transmission to reach solid effect of waterproof.

### BACKGROUND OF PRIOR ART

Please refer to FIG. 1. Accordingly, the structure of the prior Water-Ball is comprised of a base A, a motor B, a water pumping and draining device C, a model D, a waterproof separating plate B, and a transparent upper lid F. Wherein, the base A is a hollow shell body, under which several plastic seats C are arranged to reach the functions of soundproof and vibration-proof. A battery case H and a pump fixing seat I are arranged on the bottom surface of the interior of the base seat A. The motor B is located inside the motor seat J and both together are fixed on the pump fixing seat I. A waterproof lid K is arranged above the motor B. A motor axis center L extends through the penetrating hole of the waterproof lid K and the penetrating hole M of the waterproof separating plate E. Further, a ring-shaped flange N is arranged on outer circumference of the waterproof separating plate E. An indented hole P is arranged on each top surface and bottom surface of the waterproof separating plate E. An indented ring Q, arranged on the inside edge of the lower end of the transparent upper lid F, can be completely sealed and connected with the outer flange N of the waterproof separating plate E. There is a water pumping and draining device C. The water pumping and draining device C is comprised of an upper lid body R, a lower lid body S, a filter net lid T, and a rotating blade U. Wherein, a flange V is arranged on the top end of the upper lid body R and several penetrating holes W are arranged on the top end of the flange, while the filter net lid T is covered on the flange V. A draining pipe X is arranged in one side of the upper lid body R. A flange Y is arranged under the bottom end of the lower lid body S and can just placed and fixed in the indented hole P of the top surface of the waterproof separating plate E. A penetrating hole Z is arranged on the bottom surface of the flange Y. A rotating blade U is arranged between the upper lid body R and the lower lid body S. A hole is arranged on the bottom surface of the rotating blade U for providing the penetrating through and fixing of the motor axis center L. The rotating blade U can rotate synchronically with the rotation of the motor axis center L. There is a model D. The pipelines are preset inside the model D. A water entrance port for connecting pipe is arranged under the model D to connect the draining pipe X provided on the water pumping and draining device C. A water exit port is arranged on an upper position of the model D. By the fore-mentioned structure, an appropriate proportion of oil and water with different colors are poured into the closed space formed by the waterproof separating plate F and the transparent upper lid F. By the characteristic that oil is lighter than water, the water, sunk in lower layer, is injected into the upper oil layer through the pipelines preset inside the model D by the rotation motion activated by the motor B of the water pumping and draining device C. These arrangements will reach a kind of novel and special effect of optical beauty for most people. Although the for-mentioned structure can indeed reach the fore-mentioned effects, but the poor effect of waterproof bothers users in practical application. The water can not enter into the motor is a well-known fact for most of us. In order to activate the rotating blade U of the water pumping and draining device placed above the waterproof separating plate E to rotate, therefore a penetrating hole M must be arranged in the center of the waterproof separating plate E for providing the penetrating-through of motor axis center L which is connected with the rotating blade U. Therefore, in long term of usage and unable to keep closely tightness, the oil or water stored inside the interior of the Water-Ball will leak through the wall hole gap between the motor axis center L and penetrating hole M and damage the motor B and cause great inconvenience and trouble for the users.

Therefore, from above statement, the practical application of prior Water-Ball structure apparently has the existing shortcomings of water permeating and leaking caused by the poor effect of waterproof after long-term usage and these deficiencies are waiting for improvement.

In order to improve all items of shortcoming of above-mentioned Water-Ball structure, according to the present inventor's experience on design, manufacture and sales plus hard study for many years on this relative product and through continuous hard research, test and improvement, the present invention with a kind of reasonable design and capable of effectively improving above-mentioned shortcomings is finally proposed.

### SUMMARY OF THE INVENTION

The major object of the present invention is to provide a Water-Ball structure, which include a base, a motor, a water pumping and draining device, a model, a waterproof separating device, and a transparent upper lid. Wherein, each magnetic element is arranged respectively on the rotating blade of the water pumping and draining device and the axis center of the motor. When the motor, arranged under the waterproof separating plate, is rotating, it will directly active the rotating blade located above the waterproof separating plate to rotate by magnetic power. That is, without penetrating hole in the waterproof separating plate, the motor can directly active the rotating blade to rotate and to reach the solid and better function of waterproof.

To further understand and recognize the object, function and characteristic of the present invention, the esteemed review committee members please refer to the detailed description and corresponding diagrams of the present invention as following:

### BRIEF DESCRIPTION OF THE DRAWINGS

FIG. 1 is a separation three-dimensional diagram of the prior art.

FIG. 2 is a separation three-dimensional diagram of the present invention.

FIG. 3 is a section view illustration of the present invention.

### DETAILED DESCRIPTION OF THE PREFERRED EMBODIMENTS

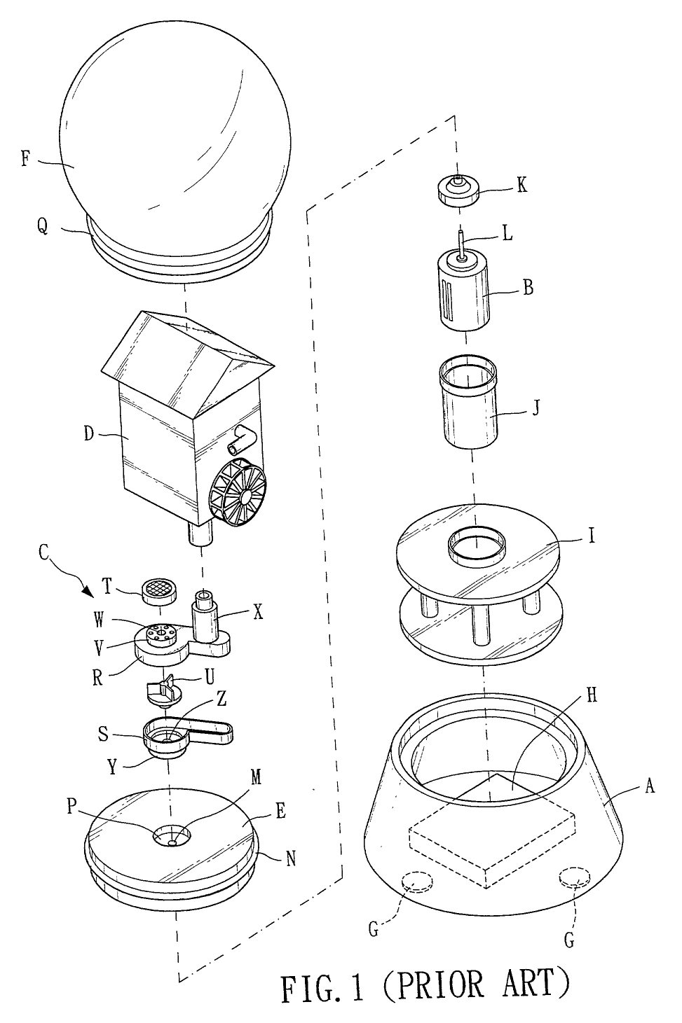

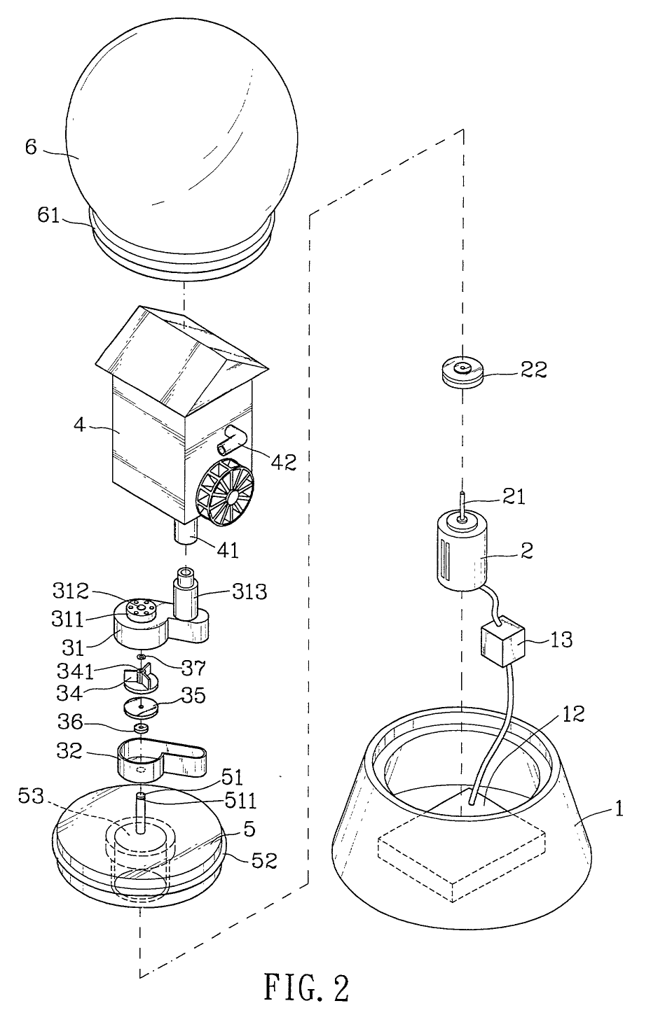

First, the esteemed review committee members please refer to FIG. 1 and FIG. 2. A Water-Ball structure of the present invention is mainly composed of a base 1, a motor 2, a water pumping and draining device 3, a model 4, a waterproof separating plate 5 and a transparent upper lid 6. Wherein, the base 1 is a hollow shell body, under which several plastic seats 11 are provided to reach the effect of soundproof and vibration-proof and a battery case 12 is also provided therein. Additionally, a fixing axis 51 is arranged on the top surface of the waterproof separating plate 5 and a ring-shaped flange 52 is arranged on the outer circumference of the waterproof separating plate 5. A motor fixing seat 53 is arranged on the bottom surface of the waterproof separating plate 5. The motor 2 is placed inside the motor fixing seat 53. A magnetic element 22 is arranged on the axis center 21 of the motor. An indented ring 61, arranged on the inside edge of the lower end of the transparent upper lid 6, can be completely sealed and connected with the outer flange 52 of the waterproof separating plate 5. There is a water pumping and draining device 3. The water pumping and draining device 3 is comprised of an upper lid body 31, a lower lid body 32, a filter net lid 33, and a rotating blade 34. Wherein, a flange 311 is arranged on the top end of the upper lid body 31 and several penetrating holes 312 are arranged on the top end of the flange, while the filter net lid 33 is covered on the flange 311. A draining pipe 313 is arranged in one side of the upper lid body 31. A rotating blade 34 is arranged between the upper lid body 31 and the lower lid body 34. A hole 341 is arranged on the bottom surface of the rotating blade 34 for providing the penetrating through and fixing of the fixing axis 51 on the waterproof separating plate 5. An additional magnetic element 35 corresponding to the magnetic element 22 arranged on the motor axis center 21 is arranged under the rotating blade 34 to make the rotating blade 34 rotate synchronically with the rotation of the motor axis center 23. There is a model 4. The pipelines are preset inside the model 4. A water entrance port 41 for connecting pipe is arranged under the model 4 to connect the draining pipe 313 provided on the water pumping and draining device 3. A water exit port 42 is arranged on an upper position of the model 4. An appropriate proportion of oil and water with different colors are poured into the closed space formed by the waterproof separating plate 5 and the transparent upper lid 6.

In the fore-mentioned structure, a washer 36 can be fitted in between the rotating blade 34 and the lower lid body 32 to reduce the friction force between the rotating blade 34 and the lower lid body 32. Additionally, the fixing axis 51 and the waterproof separating plate 5 are made by the method of forming to one body. A groove 511 is arranged on the upper portion of the fixing axis 51. After the fore-mentioned lower lid body 32, the washer 36, and the rotating blade 34 are placed in sequence onto the fixing axis 51, a moveable-fastening ring 37 can be fastened and connected with a groove 511 arranged on the fixing axis 51 to make the fore-mentioned lower lid body 32, the washer 36, and the rotating blade 34 can be stably fixed on the fixing axis 51 and without the occurrence of dropping off situation.

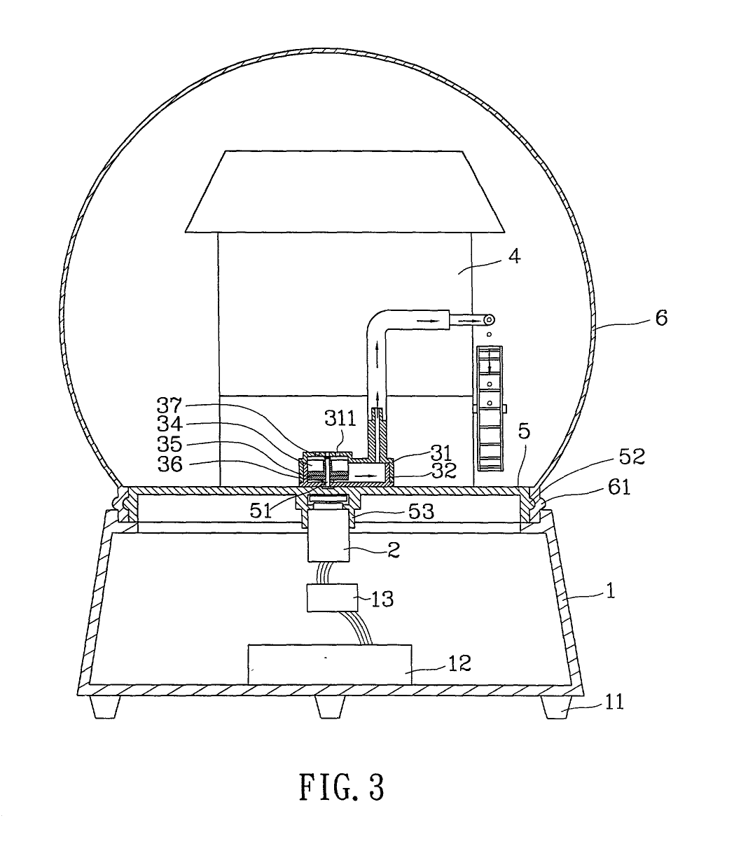

Please refer to FIG. 3 showing the section view illustration of the present invention. When the power switch is pushed on, the motor, located under the waterproof separating plate will immediately activate the magnetic element provided on the motor axis center to rotate quickly. In the mean time, the rotating blade 34, with magnetic element, located inside the water pumping and draining device 3 which is placed above the waterproof separating plate, will be activated to rotate by the principle of magnetism. Then, the water, entering from the penetrating hole 312 of the top end of the upper lid body 31, are drained out from the draining pipe 313 located on another side, flowing through the pipelines inside the interior of the model 4, and injected out from the water exiting port 42 located in the upper oil layer. The injecting water will make the waterwheel 43 located under the water exiting port 42 rotating continuously. Since the water and oil are in different colors, so the fore-mentioned motion can be seen obviously and further add the optical effect for most people.

Further, battery can be used in the motor 2 of the present invention and an electric socket can also supply the necessary power for the motor. Additionally, a sound control switch 13 can be also installed in the present invention to control the rotation of the motor 2 to reach the double functions of automatic operation and electricity saving and has a further practical usage.

The above-descriptions are the preferable embodiments of the present invention, however, the covered scope of the present invention is not limited to the embodiments shown in this invention. Any changes according to the content of the present invention and the resulted functions and characteristics are similar to the embodiments of the present invention and the ideas created by all such technology well-known persons are all belonged to the covering scopes of the present invention. For example, the model constructed on the pumping and draining device is not restricted to the water-wheel-house shown in the figures, etc.

What is claimed is:

1. A Water-Ball structure of the present invention is mainly composed of a base, a motor, a water pumping and draining device, a model, a waterproof separating plate and a transparent upper lid. Wherein, the base is a hollow shell body, under which a battery case is provided. Additionally, a ring-shaped flange is arranged on the outer circumference of the waterproof separating plate. An indented ring, arranged on the inside edge of the lower end of the transparent upper lid, can be completely sealed and connected with the outer flange of the waterproof separating plate. There is a water pumping and draining device. The water pumping and draining device is comprised of an upper lid body, a lower lid body, a filter net lid, and a rotating blade. Wherein, a flange is arranged on the top end of the upper lid body and several penetrating holes are arranged on the top end of the flange, while the filter net lid is covered on the flange. A draining pipe is arranged in one side of the upper lid body. A rotating blade is arranged between the upper lid body and the lower lid body. A hole is arranged on the bottom surface of the rotating blade for providing the penetrating through and fixing of the fixing axis arranged on the waterproof separating plate. There is a model. The pipelines are preset inside the model. A water entrance port for connecting pipe is arranged under the model to connect the draining pipe provided on the water pumping and draining device. A water exit port is arranged on an upper position of the model. An appropriate proportion of oil and water with different colors are poured into the closed space formed by the waterproof separating plate and the transparent upper lid. The characteristics are: A fixing axis is arranged on the top surface of the waterproof separating plate and a motor fixing seat is arranged on the bottom surface of the waterproof separating plate. The motor is directly placed inside the motor fixing seat. A magnetic element is arranged on the axis center of the motor. Additionally, a magnetic element corresponding to fore-said magnetic element arranged on the motor axis center is arranged under the rotating blade.

2. A Water-Ball structure according to the claim 1, wherein, several plastic seats are arranged on the bottom portion of said base.

3. A Water-Ball structure according to the claim 1, wherein, a washer can be fitted in between said rotating blade and said lower lid body.

4. A Water-Ball structure according to the claim 1, wherein, said fixing axis and said waterproof separating plate are made by the method of forming to one body.

5. A Water-Ball structure according to the claim 1, wherein, a groove is arranged on the upper portion of said fixing axis.

6. A Water-Ball structure according to the claim 1, wherein, a sound control switch is arranged in the present invention and the sound control switch can control the rotation of said motor.
